(19) United States
(12) Patent Application Publication
(10) Pub. No.: US 2004/0085020 A1
(43) Pub. Date: May 6, 2004

(54) Pattern display apparatus

(75) Inventors: Shinichi Handa, Tokyo-To (JP); Hirofumi Nakajima, Tokyo-To (JP); Kenichi Kuba, Tokyo-To (JP); Masaru Kobayashi, Tokyo-To (JP); Hiroyuki Shirogane, Tokyo-To (JP)

Correspondence Address: PARKHURST & WENDEL, L.L.P., 1421 PRINCE STREET, SUITE 210, ALEXANDRIA, VA, 22314-2805, US

(73) Assignee: Dai Nippon Prtg Co., Ltd., Shinjuku-Ku (JP)

(21) Appl. No.: 10/664,036

(22) Filed: Sep. 17, 2003

(30) Foreign Application Priority Data
Sep. 17, 2002 (JP) 2002-270614

(51) Int. Cl. H01J 1/62

(52) U.S. Cl. 313/511

(57) ABSTRACT

The present invention is a pattern display apparatus including a rotary or stationary display member; and a flexible organic EL device provided on an outer surface of the rotary or stationary display member, the flexible organic EL device being capable of displaying a character, a figure, a mark and/or a pattern formed by combining some of a character, a figure and a mark. According to the feature, the self-luminescent organic EL device provided on the outer surface of the rotary display member or the stationary display member can be driven by a low voltage to emit bright light and is also capable of emitting light in multiple colors. Therefore, the problems in the conventional pattern display apparatus using light bulbs as light sources do not arise in the pattern display apparatus of the present invention.

### BACKGROUND OF THE INVENTION

1. Field of the Invention

The present invention relates to a pattern display apparatus including a rotary display member for a game machine, for example a slot machine or a pachinko machine, or a stationary display device for point-of-purchase advertisement (POP advertisement). More specifically, the present invention relates to a pattern display apparatus including a display member having a flexible organic electroluminescent (hereinafter referred to as “EL”) device.

2. Description of the Related Art

Generally, a pattern display apparatus incorporated into a game machine, such as a slot machine or a pachinko machine, is provided with a plurality of rotary members (generally, three rotary members), such as drums (also called reels) or belts, on which respective patterns are depicted. The rotary members rotate to display a variable patterning, and stop to display a still patterning. The pattern display apparatus indicates success (win) or failure by the still patterning (combination of still patterns) along a straight line called a success line or a win line.

Studies for a display format of the pattern display apparatus have been made in order to allow the player to clearly recognize the alignment of the drums on specific positions. Recent pattern display apparatuses include a light-emitting display panel provided with a high-luminance EL device. In a technique disclosed in Japanese Patent Publication No. 2000-229145 (claims, FIGS. 6 and 11), a light-emitting display panel provided with an EL device is attached on the front surface of a drum, and displays a luminous line, a luminous frame or a luminous plane in order to improve the effect of display. In another technique disclosed in Japanese Patent Publication Laid-Open No. 2002-85624 (claims, FIGS. 2 and 3), a plurality of light-emitting panels, each of which is provided with an EL device, are attached on the respective front surfaces of drums. The EL device in the foregoing light-emitting display panel emits light by exciting a fluorescent compound therein by an electric field. Such a self-luminescent light-emitting display panel has a high visibility and is excellent in shock resistance because it is a complete solid body.

Although the light-emitting panel included in the foregoing conventional pattern display apparatus displays a luminous line, a luminous frame or a luminous plane to indicate a success line or a win line, the light-emitting panel does not display characters and patterns. Light bulbs placed in the cylindrical drums are turned on in order to show characters and patterns formed on the surfaces of the drums.

Therefore, the burnt-out light bulbs must be replaced with new ones, or the light bulbs must be replaced periodically with new ones. In addition, the characters and patterns may not be clearly visible if there is a difference in respective luminance of new and old light bulbs. Furthermore, light bulbs must be used in one-to-one combination with the characters and patterns to display the characters and the patterns at the same level of brightness. In addition, color light bulbs must be combined with the characters and the patterns, respectively, to display the characters and the patterns in colors. Furthermore, there is the possibility that electronic circuits placed inside the drums are affected adversely by heat generated by the light bulbs.

### SUMMARY OF THE INVENTION

The present invention has been made to solve the foregoing problems and it is therefore an object of the present invention to provide a pattern display apparatus including a rotary display device incorporated into a game machine such as a slot machine or a pachinko machine, or including a stationary display device for POP advertisement, and capable of stably displaying individual characters and patterns in high brightness and excellent visibility.

The invention is a pattern display apparatus comprising: a rotary or stationary display member; and a flexible organic EL device provided on an outer surface of the rotary or stationary display member, the flexible organic EL device being capable of displaying a character, a figure, a mark and/or a pattern formed by combining some of a character, a figure and a mark.

According to the feature, the self-luminescent organic EL device provided on the outer surface of the rotary display member or the stationary display member can be driven by a low voltage to emit bright light and is also capable of emitting light in multiple colors. Therefore, the problems in the conventional pattern display apparatus using light bulbs as light sources do not arise in the pattern display apparatus of the present invention. Thus, the pattern display apparatus has an improved amusing effect and an improved soliciting effect, i.e., a publicizing and advertising effect on soliciting purchasers to purchase things, and is also advantageous in respect of maintenance and management.

Preferably, the rotary display member rotates to display a variable patterning and stops to display a still patterning for a game machine.

Preferably, the stationary display device is for POP advertisement.

Preferably, the flexible organic EL device has a laminated structure formed by laminating at least a flexible base layer, a first electrode layer, an EL layer, a second electrode layer and a flexible sealing layer in that order. More preferably, an insulating layer of a predetermined pattern is provided for insulating the first electrode layer and the second electrode layer from each other in the laminated structure.

According to the feature, since both the base layer and the sealing layer on the opposite side are flexible, the organic EL device is satisfactorily flexible and hence can satisfactorily be mounted on the rotary display member or the stationary display member. Since the insulating layer defines a light-emitting region of a predetermined pattern, the light-emitting region is able to display a character, a figure, a mark or a pattern formed by combining some of a character, a figure and a mark. Thus, the pattern display apparatus can display a bright character, pattern and so on, having improved amusing and soliciting effects.

### BRIEF DESCRIPTION OF THE DRAWINGS

FIG. 1 is a perspective view of a pattern display apparatus in a first embodiment according to the present invention, which is provided with rotary display members;

FIGS. 2A and 2B are perspective views of pattern display apparatuses in second and third embodiments according to the present invention, each of which is provided with a rotary display device;

FIGS. 3A and 3B are perspective views of pattern display apparatuses in fourth and fifth embodiment according to the present invention, each of which is provided with a stationary display device;

FIG. 4 is a perspective view of a slot machine provided with a pattern display apparatus according to the present invention;

FIG. 5 is a typical sectional view of an example of flexible, organic EL device included in a pattern display apparatus according to the present invention;

FIG. 6 is plan views of examples of flexible, organic EL devices;

FIG. 7 is a plan view of other examples of flexible, organic EL devices; and

FIG. 8 is a plan view of other examples of flexible, organic EL devices.

### DESCRIPTION OF THE PREFERRED EMBODIMENTS

Pattern display apparatuses in preferred embodiments according to the present invention will be described hereinafter.

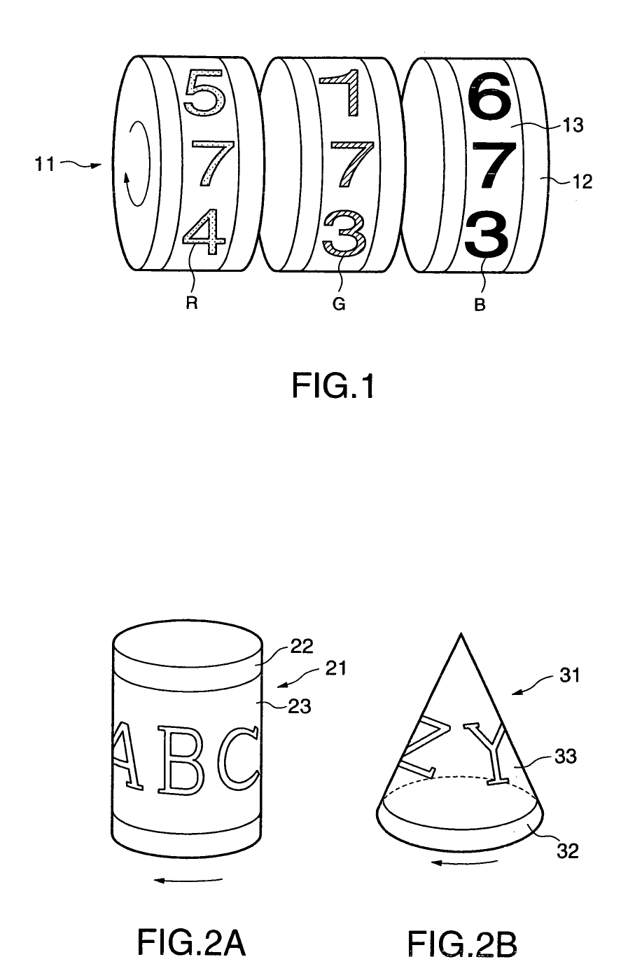

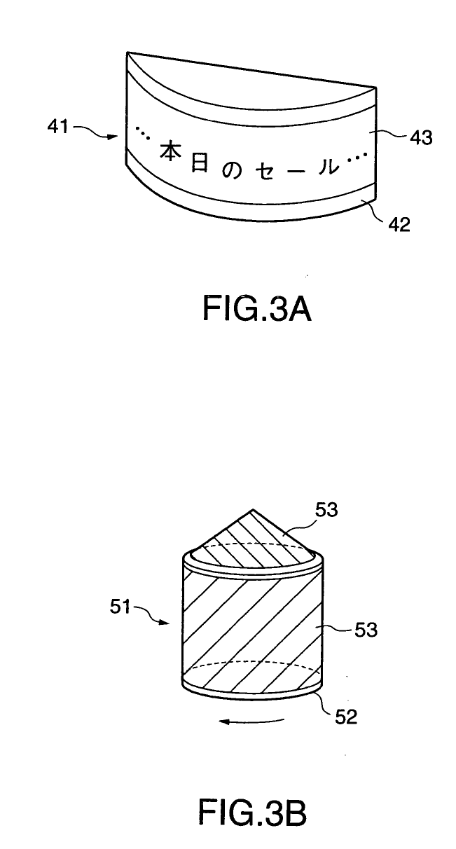

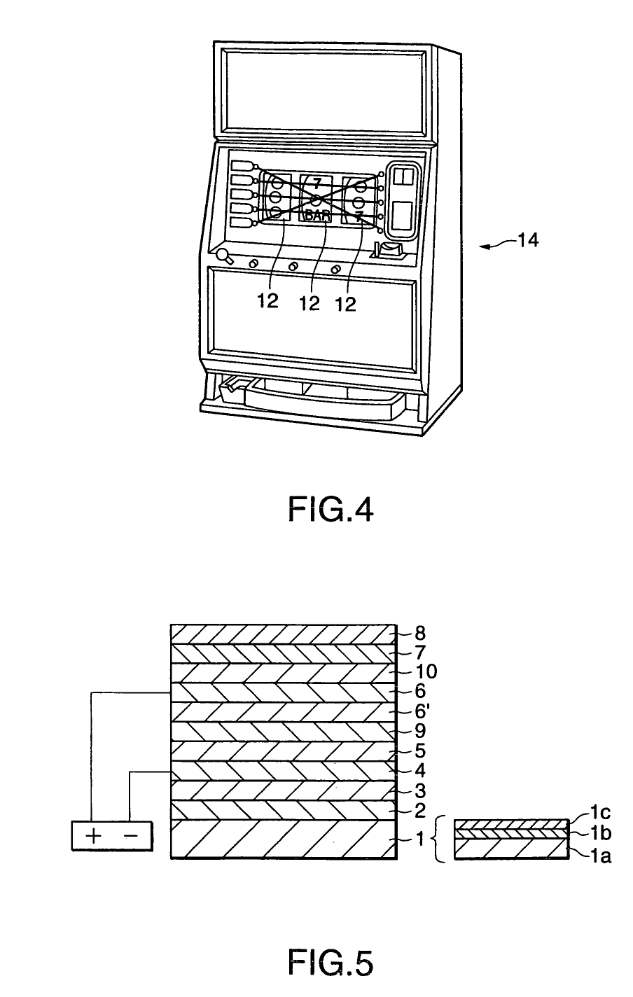

FIG. 1 shows a perspective view of a pattern display apparatus in a first embodiment according to the present invention, which is provided with rotary display members. FIGS. 2A and 2B show pattern display apparatuses in second and third embodiments according to the present invention, each of which is provided with a rotary display device. FIGS. 3A and 3B show pattern display apparatuses in fourth and fifth embodiment according to the present invention, each of which is provided with a stationary display device. FIG. 4 shows a slot machine provided with a pattern display apparatus according to the present invention.

As shown in FIGS. 1 to 3, pattern display apparatuses 11, 21, 31, 41 and 51 embodying the present invention are provided with rotary display members 12, 22 and 32, and stationary display members 42 and 52, respectively. Flexible, organic EL devices 13, 23, 33, 43 and 53 are attached to the outer surfaces of the rotary display members 12, 22 and 32 and the stationary display members 42 and 52, respectively. The flexible, organic EL devices 13, 23, 33, 43 and 53 are capable of displaying characters, figures, marks or patterns formed by combining some of the characters, figures and/or marks.

As shown in FIGS. 1 and 2, the rotary display members 12, 22 and 32 may be of any shape, provided that the rotary display members 12, 22 and 32 are able to rotate and display patterns. For example, each of the rotary display members 12, 22 and 32 may have the shape of a cylinder, a column, a prism such as a triangular prism or any one of polygonal prisms, or a pyramid such as a triangular pyramid or any one of polygonal pyramids. Alternatively, each of the rotary display members 12, 22 and 32 may have a composite shape formed by combining a cylinder, a column, a prism and/or a pyramid. There is no dimensional restriction on the rotary display members 12, 22 and 32.

As shown in FIG. 3, the stationary display members 42 and 52 may be of any shape, provided that the stationary display members 42 and 52 are able to display patterns in a stationary state. For example, each of the stationary display members 42 and 52 may have the shape of a cylinder, a column, a prism such as a triangular prism or a polygonal prism, a pyramid such as a triangular pyramid or any one of polygonal pyramids, similarly to the rotary display members. Alternatively, each of the stationary display members 42 and 52 may also have a composite shape formed by combining a cylinder, a column, a prism and/or a pyramid. There is no dimensional restriction on the stationary display members 42 and 52.

The flexible, organic EL devices 13, 23, 33, 43 and 53 are respectively attached on the outer surfaces of the rotary display members and the stationary display members. The flexible, organic EL devices are formed to display characters, figures, marks or patterns formed by combining characters, figures and/or marks, meeting to purposes.

For example, when the rotary display members 12 shown in FIG. 1 are incorporated into a slot machine 14 shown in FIG. 4, a rectangular, flexible, organic EL device 13 carrying a patterning formed by arranging characters, patterns or such in a row is wound around each of the rotary display members 12. When the rotary display members 22 and 32 shown in FIGS. 2A and 2B are employed in standing signboards at shops for POP advertisement, flexible, organic EL devices carrying patterns for advertisement or guidance are applied to the outer surfaces of the rotary display members 22 and 23, respectively.

The rotary display members and the stationary display members included in the pattern display apparatuses embodying the present invention are not provided internally with any light sources, such as electric light bulbs, and the flexible organic EL devices that can easily be made to conform to the surfaces of members are wound around the rotary and the stationary display members. Thus, the rotary and the stationary display members are free from troubles attributable to light sources. The flexible, organic EL device is also capable of displaying animations and of changing displayed images at predetermined time intervals or periodically. Thus, when the pattern display apparatus of the present invention is applied to a game machine, such as a slot machine or a pachinko machine, the pattern display apparatus provides the game machine with potentials that could not have been expected by the conventional game machines, and thereby the amusing effect of the game machine can remarkably be improved. On the other hand, when the pattern display apparatus of the present invention is applied to a POP advertisement apparatus, the pattern display apparatus enhances the soliciting effect of the POP advertisement apparatus and the effect of the POP advertisement apparatus in attracting the interest of purchasers.

The flexible, organic EL devices employed in the foregoing pattern display apparatuses will be described in detail. FIG. 5 shows one of the flexible, organic EL devices 13, 23, 33, 43 and 53 by way of example. The flexible, organic EL device is formed by superposing, at least, a flexible base layer 2, a first electrode layer 4, an EL layer 5, a second electrode layer 6, and flexible sealing layers 8 and 10 in that order.

### Printed Protective Layer 1

A printed protective layer 1 is a transparent layer. The Printed protective layer 1 is not essential and is used when necessary. The printed protective layer 1 is formed by superposing a base film 1a, a printed layer 1b and an adhesive layer 1c in that order. The base film 1a faces users. The base film 1a may be the same resin film as that forming the flexible base layer 2. The printed layer 1b may be printed in a solid color or may be printed with a pattern meeting uses. Printing inks ordinarily used in this field may be used for printing the printed layer 1b. The adhesive layer 1c bonds the printed protective layer 1 adhesively to the flexible base layer 2. Representative adhesive materials for forming the adhesive layer 1c are urethane adhesives, epoxy adhesives, acrylic adhesives, vinyl adhesives, isocyanate adhesives, and so on. Preferably, the thickness of the printed protective layer 1 is in the range of about 200 to about 300 μm.

### Flexible Base Layer 2

The flexible base layer 2 forms an anterior surface facing users (players or purchasers). Therefore, the degree of transparency of the flexible base layer 2 must be high enough to enable the users to easily and visually recognize characters, figures, marks or patterns formed by combining characters, figures and/or marks (hereinafter, referred to as “pattern of characters and the like”) formed by luminescence of the EL layer 5.

The flexible base layer 2 is a resin film or a sheet formed by applying a protective plastic sheet or a protective plastic layer to a thin sheet glass of a thickness not greater than about 100 μm. The flexible base layer 2, which is highly flexible and can be rolled and curved, is a preferable flexible base layer to be applied to the rotary display member or the stationary display member.

There is no particular restrictions on the material of the flexible base layer 2, provided that the flexible base layer 2 has a sufficient flexibility required of a flexible base layer for a flexible, organic EL device. More concretely, materials suitable for forming the flexible base layer 2 include, fluorine resins, polyethylene resins, polypropylene resins, polyvinyl chloride resins, polyvinyl fluoride resins, polystyrene resins, ABS resins, polyamide resins, polyacetal resins, polyester resins, polycarbonate resins, modified poly(phenylene ether) resins, polysulfone resins, polyarylate resins, poly(ether imide) resins, polyamidimde resins, polyimide resins, polyphenylene sulfide resins, liquid crystalline polyester resins, polyethylene terephthalate resins, polybutylene terephthalate resins, polyethylene naphthalate resins, polyoxymethylene resins, poly(ether sulphone) resins, poly(ether ether ketone) resins, polyacrylate resins, polyacrylonitrile-styrene resins, phenolic resins, urea resins, melamine resins, unsaturated polyester resins, epoxy resins, polyurethane resins, silicone resins and amorphous polyolefin resins. The flexible base layer 2 may be formed of any suitable polymer, other than the foregoing resins, meeting conditions required of materials for forming a flexible, organic EL device. The flexible base layer 2 may be formed of a copolymer produced through copolymerization of some of the starting materials, i.e. monomers, of the foregoing resins.

More preferably, the flexible base layer 2 is formed of a resin satisfactory in solvent resistance and heat resistance and, if an environment in which the pattern display apparatus is to be used requires, having a gas-barrier property capable of preventing penetration of steam and oxygen gas. When a resin material having the gas-barrier property is used, a barrier layer 3, which will be described later, may be omitted. However, it is preferable that the organic EL device is provided with both the flexible base layer 2 and the barrier layer 3. Preferably, the flexible base layer 2 is a film of a thickness in the range of 50 to 200 μm.

A sheet, as the flexible base layer 2, formed by applying a protective plastic sheet or a protective plastic layer to a thin sheet glass of a thickness not greater than about 100 μm is excellent in flexibility, can be rolled or curved, and hence is a preferable flexible base layer 2. Preferably, the protective plastic sheet or the protective plastic layer has a satisfactory gas-barrier property.

### Barrier Layer 3

Although the barrier layer 3 is not an essential layer, it is preferable to sandwich the barrier layer 3 between the flexible base layer 2 and the first electrode layer 4. The barrier layer 3 prevents penetration of moisture (steam) and oxygen gas, which affects adversely to the life and luminescent ability of the organic EL layer 5, into the organic EL layer 5. The barrier layer 3, similarly to the flexible base layer 2, must be transparent.

Preferably, the barrier layer 3 is an inorganic oxide thin film. Inorganic oxides suitable for forming the barrier layer 3 include, for example, silicon dioxide, aluminum oxide, titanium oxide, yttrium oxide, germanium oxide, zinc oxide, magnesium oxide, calcium oxide, boron oxide, strontium oxide, barium oxide, lead oxide, zirconium oxide, sodium oxide, lithium oxide and potassium oxide. The barrier layer 3 may be formed of one or some of those oxides. Silicon dioxide, aluminum oxide and titanium oxide are particularly preferable materials for forming the barrier layer 3. The barrier layer 3 may be also formed of a material other than an inorganic oxide, such as silicon nitride. Preferably, the thickness of the barrier layer 3 is in the range of 0.01 to 0.5 μm.

The barrier layer 3 is formed between the flexible base layer 2 and the first electrode layer 4, for example, on the flexible base layer 2 by a physical vapor deposition process, such as a reactive sputtering process or a vacuum evaporation process.

### First and Second Electrode Layers

The first electrode layer 4 and the second electrode layer 6 are essential layers to apply an electric field to the EL layer 5. The first electrode layer 4 is on the side of the flexible layer 2 with respect to the EL layer 5, and the second electrode layer 6 is on the side of the flexible sealing layers 8 and 10 with respect to the EL layer 5. At least the first electrode layer 4 facing the user, similarly to the flexible base layer 2 and the barrier layer 3, must be transparent. The second electrode layer 6 does not necessarily need to be transparent.

Suitable materials for forming the first electrode layer 4 include, for example, indium tin oxide (ITO) indium oxide, indium zinc oxide (IZO), gold and polyaniline. Indium tin oxide and indium zinc oxide, which are transparent oxides, are particularly preferable.

Suitable materials for forming the second electrode layer 6 include, in addition to indium tin oxide (ITO), indium oxide, indium zinc oxide (IZO), gold and polyaniline, magnesium alloys, such as Mg/Ag alloys, aluminum alloys, such as Al/Li alloys, Al/Ca alloys and Al/Mg alloys, and metallic calcium.

Preferably, the respective thicknesses of the first electrode layer 4 and the second electrode layer 6 are 500 nm or below, more preferably, 300 nm or below. Usually, the first electrode layer 4 and the second electrode layer 6 are formed contiguously with the EL layer 5 by a physical evaporation process, such as a sputtering process or a vacuum evaporation process. The first electrode layer 4 and the second electrode layer 6 may be either solid layers or patterned layers pattered so as to correspond to the EL layer 5. A patterned electrode layer is formed by subjecting a solid electrode layer to an etching process using a photoresist mask.

### EL Layer 5

The EL layer 5 is indispensable. The EL layer 5 may be of generally known construction. For example, the EL layer 5 may be: an organic luminescent layer containing an organic luminescent substance, such as an organic fluorescent substance, and being formed between electrode layers; a layered structure consisting of an organic luminescent layer, a hole-transporting layer of a hole-transporting material formed on a surface of the organic luminescent layer on the side of an anode, and an electron-transporting layer of an electron-transporting material formed on the other surface of the organic luminescent layer on the side of a cathode; a layered structure consisting of an organic luminescent layer having the property of a hole-transporting layer, and an electron-transporting layer formed on a surface of the organic luminescent layer on the side of a cathode; or a layered structure consisting of an organic luminescent layer having the property of an electron-transporting layer, and a hole-transporting layer formed on a surface of the organic luminescent layer on the side of anode.

The organic luminescent layer containing an organic luminescent substance may be formed of an azo compound generally used for forming an organic EL layer. The organic luminescent layer may be also formed of an azo compound containing an organic luminescent substance. Suitable organic luminescent substances include pyrene, anthracene, naphthacene, phenanthrene, coronene, chrysene, fluorene, perylene, perynone, diphenylbutadiene, coumarin, styryl, pyrazine, aminoquinoline, imine, diphenylethylene, merocyanine, quinacridone, rubrene and derivatives of those substances. An organic luminescent layer is formed by using an organic luminescent layer forming liquid containing such a compound.

The hole-transporting material may be chosen from generally used hole-transporting materials including phthalocyanine, naphthalocyanine, polyphylene, oxadiazole, triphenylamine, triazole, imidazole, imidazolone, tetrahydroimiazole, hydrazone, stilbene, butadiene and derivatives of those substances. The hole-transporting material may be a hole-transporting layer forming composition on the market, such as poly(3,4)ethylene dioxithiophene/polystyrenesulfonate (abbreviated to PEDOT/PSS), such as Baytron P AI4083 commercially available in an aqueous solution from Bayer. The hole-transporting layer is formed by using a hole-transporting layer forming liquid containing such a compound.

Suitable electron-transporting materials include anthraquinodimethane, fluorenylidenemethane, tetracyanoethylene, fluorenone, diphenoquinone oxadiazole, anthrone, thiopyran dioxide, diphenoquinone, benzoquinone, malononitrile, dinitrobenzene, nitroanthraquinone, maleic anhydride, perylene tetracarboxylic acid and derivatives of those substances. The electron-transporting layer is formed by using an electron-transporting layer forming liquid containing such a substance.

The EL layer may be formed, according to the above-mentioned layered structure forming mode, by pouring an organic luminescent layer forming liquid, a hole-transporting layer forming liquid and an electron-transporting layer forming liquid in predetermined spaces demarcated by partition walls. Those liquids may be poured by a dispenser process using a dispenser for dropping a liquid, an ink-jet process, a spin-coating process or a printing process. Preferably, the EL layer is formed by a printing process, such as a gravure printing process, a gravure-offset printing process or an ink-jet printing process, under roll-to-roll manufacturing conditions. The ink-jet printing method is particularly preferable for printing a pattern because: the ink-jet printing method is able to apply the liquid to a base without touching and damaging the base; does not need any printing plate; and hence has a high degree of freedom. The productivity of forming the EL layer can be more improved by forming that by one of those printing processes. The poured liquids are subjected to a heat treatment, such as a vacuum heat treatment. Preferably, the thickness of the EL layer 5 in the above-mentioned layered structures is in the range of 0.1 to 2.5 μm.

The partition walls, not shown, demarcate regions that become luminous in different colors on the surface of the organic EL device. A hole-transporting layer forming liquid, an organic luminescent layer forming liquid, and an electron-transporting layer forming liquid are respectively poured into the regions demarcated by the partition walls, according to the above-mentioned layered structure forming mode. The partition walls may be formed of a generally used partition wall forming material, such as a photopolymer, a curable resin that can be cured by radiation having activation energy, a thermosetting resin or a thermoplastic resin. The partition walls may be formed by a method suitable for forming the partition walls with a selected material. For example, the partition walls may be formed by a thick-film printing process or a patterning process using a photoresist mask.

### Insulating Layer 9

The insulating layer 9 is not essential. The insulating layer 9 is formed in a predetermined pattern between the first electrode layer 4 and the second electrode layer 6, and defines light-emitting regions in a predetermined pattern. Since the insulating layer 9 nullifies the effect of a voltage applied between the electrode layers 4 and 6, the regions defined by the insulating layer 9 in the EL layer 5 do not emit light. That is, the regions corresponding to the patterned insulating layer 9 are nonluminous regions, which define luminous regions for display. On the other hand, in the luminous regions not corresponding to the patterned insulating layer 9, since the electrodes 4 and 6 are contiguous with the opposite surfaces of the EL layer 5, a voltage is applied between the luminous regions of the EL layer 5 to exert the soliciting effects.

Thus, if the insulating layer 9 is formed in a pattern of characters and the like, the pattern of characters and the like can be formed by luminous regions having excellent soliciting effects.

Such a pattern of characters and the like may be a pattern consisting of several sections or may be a simple outlined pattern. In addition, the insulating layer 9 may be a dot layer formed of dots. Alternatively, in order to create a display screen in which a character is shown as if it moves in a fixed direction, the insulating layer may be formed in a simple outlined pattern, the EL layer may be divided into a dot matrix pattern, and each element of the dot matrix pattern may be individually controlled to be luminous.

The insulating layer 9 may be laminated to either the first electrode layer 4 or the second electrode layer 6. Usually, a resist material for forming the insulating layer is transparent, and hence a patterned insulating layer (resist layer) is also hardly visible. Therefore, the insulating layer scarcely affects the visibility of the organic EL device. For example, the insulating layer 9 is formed into a desired pattern from a photosensitive resin by photolithography. The thickness of the insulating layer 9 is, in general, in the range of 0.1 to 10 μm.

### Sealing Layer 10

The sealing layer 10 is flexible. The sealing layer 10 is preferably provided in order to fill (eliminate) and seal gaps between an organic EL element including the EL layer and the flexible sealing element 8. The sealing layer 10 is formed of a generally used sealing material. Preferably, the sealing layer 10 is formed of a thermosetting epoxy adhesive or a UV-curable acrylic adhesive.

The sealing layer 10 has a barrier property when formed of a material having a barrier property. Therefore, the barrier layer 7 and the flexible sealing layer 8 may be omitted, so that only the sealing layer 10 may be formed on the back side, i.e., the side away from the users with respect to the EL layer.

The sealing layer 10 may be directly formed on the organic EL element so as to entirely coat a surface of the organic EL element, or may be formed on the flexible sealing layer 8 and then applied to the organic EL element. Preferably, the sealing layer 10 is formed in the least possible thickness provided that the sealing layer 10 is able to seal the gaps. The thickness of the sealing layer 10 may properly be adjusted. The sealing layer 10 is hardened under thermosetting or curing conditions depending on the material of the sealing layer 10.

Preferably, the sealing layer 10 entirely coats the surface of the EL element. If a sealing layer is formed on a glass substrate by a conventional frame-like application process, a middle part of the sealing layer may touch the EL element when a panel is curved even after applying the sealing layer to the glass substrate. Such a trouble can be prevented by forming the sealing layer 10 over the entire surface of the EL element. Thus, the organic EL device provided with the sealing layer coating the entire surface of the EL element does not have any gaps therein. Therefore, the organic EL device will not be unnecessarily strained and tensioned even when rolled or curved, and hence troubles including abnormal contact in the EL element can be suppressed. In addition, if the sealing layer itself has a barrier property, the sealing layer entirely coating the surface of the EL element improves the sealing effect to suppress the penetration of moisture and gases into the EL element, which improves the protecting effect for the EL element.

### Barrier Layer 7

The barrier layer 7 is not essential. Preferably, the barrier layer 7 is formed on the side of the EL layer 5 with respect to the flexible sealing layer 8. The barrier layer 7 is formed between the flexible sealing layer 8 and the second electrode layer 6, more concretely, between the flexible sealing layer 8 and the sealing layer 10. The operation and effect of the barrier layer 7 are the same as those of the barrier layer 3. Although there is no particular restriction on the material of the barrier layer 7, it is preferable to form the barrier layers 3 and 7 of the same material.

The barrier layer 7 is formed on the flexible sealing layer 8 by a physical deposition process, such as a reactive sputtering process or a vacuum deposition process. The barrier layer 7 is formed by a physical deposition system that conveys the flexible sealing layer 8, which has the shape of a film, according to a roll-to-roll method.

### Flexible Sealing Layer 8

The flexible sealing layer 8 is a posterior layer opposite the anterior layer facing users. Therefore, the flexible sealing layer 8 does not need to be transparent, but may be transparent.

The flexible sealing layer 8 is a flexible resin film capable of being rolled or curved. Therefore, the flexible sealing layer 8 is preferably used as a base layer for an organic EL device that can be attached to various structures. The material of the flexible sealing layer 8 and the method for forming the same are the same as those mentioned in connection with the flexible base layer 2, and hence the description thereof will be omitted. Preferably, the thickness of the flexible sealing layer 8, similarly to that of the flexible base layer 2, is in the range of 50 to 200 μm. The flexible sealing layer 8 of such a thickness has flexibility suitable for use on the organic EL device.

### Organic EL Device

Although the basic layered structure of the organic EL device of the pattern display apparatus according to the present invention has been described, the organic EL device may be provided with additional functional layers other than those mentioned above, provided that the additional functional layers do not affect adversely to the essential functions of the organic EL device.

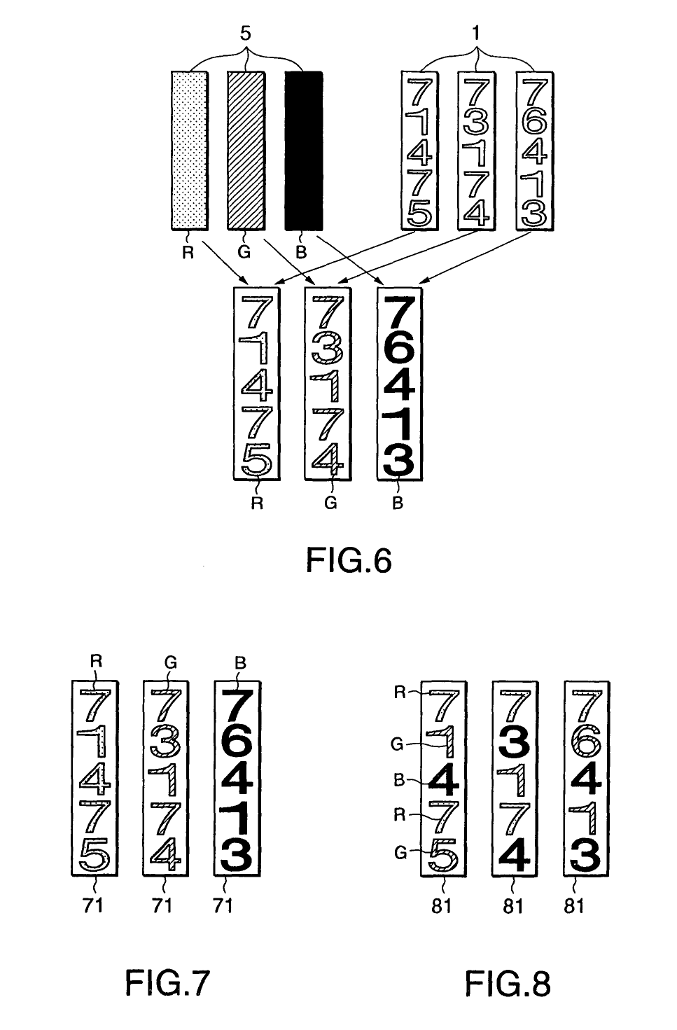

FIGS. 6 to 8 are plan views of examples of flexible organic EL devices to be applied to the slot machine shown in FIG. 4. In FIGS. 6 to 8, letters R, G and B indicate red, green and blue, respectively.

Organic EL devices 61 shown in FIG. 6 are formed by bonding together EL layers 5 becoming luminous in sold colors, respectively, and printed layers 1 provided with transparent patterns through which the EL layers 5 underlying the printed layers 1 can be seen, respectively. Light emitted from regions, corresponding to the transparent patterns of the printed layers 1, of the EL layers 5 displays the patterns conspicuously. An application of the organic EL devices 61 to a slot machine or the like may enable display of the patterns and the like that enhance the pleasure of playing with the machine and the amusement thereof.

Organic EL devices 71 shown in FIG. 7 have EL layers, and the EL layers of each organic EL device 71 display respective patterns in the same color. The EL layers are formed continuously by a printing process, such as a gravure printing process, a flexographic process or an offset printing process. Alternatively, organic EL devices of this type can be formed by forming the EL layers 5 becoming luminous in solid colors, and then forming the insulating layers 9 into desired patterns.

Organic EL devices 81 shown in FIG. 8 have EL layers, and the EL layers of each organic EL device 81 display respective patterns in different colors. The EL layers are also formed by a printing process, such as a gravure printing process, a flexographic process or an offset printing process. Alternatively, organic EL devices of this type can be formed by forming the EL layers 5 becoming luminous in solid colors, and then forming the insulating layers 9 into desired patterns.

Preferably, the respective thicknesses of the component layers of the organic EL device are selectively determined such that the thickness of the organic EL device is not greater than 400 μm, preferably, between 50 and 200 μm. The organic EL device having a thickness meeting the foregoing condition is flexible and can be rolled and curved, and hence the organic EL device can easily be mounted on the rotary display member or the stationary display member. An organic EL display having a thickness greater than 400 μm is somewhat inferior in flexibility.

Preferably, the organic EL device is mounted on a rotary display member or a stationary display member by a means that may not affect adversely to a power circuit that drives the organic EL device for light emission, such as an adhesive or a sticky material.

In fabricating the organic EL device, the component layers of the organic EL device can continuously be formed by wet processes. Therefore, the pattern display apparatus employing the organic EL device can be placed on the market at a reasonable price. For example, (1) the flexible base layer 2 provided with the barrier layer 3, and the flexible sealing layer 8 provided with the barrier layer 7 are formed by a continuous vapor deposition process, (2) the first electrode layer 4 is formed by a reactive sputtering process on the barrier layer 3 formed on the flexible base layer 2, (3) the EL layer 5 is formed by a printing process on the first electrode layer 4, (4) the second electrode layer 6 is formed by a vacuum evaporation process on the EL layer 5, (5) the sealing layer 10 is formed by applying a sealing agent to the second electrode layer 6, and (6) the flexible sealing layer 8 provided with the barrier layer 7 is bonded to the sealing layer 10. Thus, the organic EL device can efficiently be manufactured by using wet processes in many steps in accordance with a roll-to-roll continuous manufacturing method, which is superior in productivity.

### EXAMPLE

An example of the pattern display apparatus according to the present invention will be described.

An organic EL device was fabricated by the following processes.

A 100 μm thick flexible base layer 2 of a poly(ether sulphone) resin was formed by an extrusion process. A 0.1 μm thick barrier layer 3 of SiON was formed by a continuous vapor deposition system on the flexible base layer 2. A 0.1 μm thick anode layer of ITO was formed by a sputtering process on the barrier layer 3. A 1 μm thick insulating layer of a photoresist was formed by a spin-coating process on the anode layer. The insulating layer was patterned by photolithography, that is, the insulating layer was exposed to an exposure source through a mask of a predetermined pattern and the exposed insulating layer was developed. Thus, a patterned insulating layer having a patterning of letters as shown in FIG. 6 is completed. A 150 nm thick EL layer 5 of a mixture of a hole-transporting material and an organic luminescent material was formed by a printing process over the anode layer covered with the patterned insulating layer. A cathode layer consisting of a 0.008 μm thick metallic calcium layer and a 0.5 μm thick silver layer was formed by a vacuum deposition process on the EL layer 5. An about 150 μm thick sealing layer of a two-part thermosetting epoxy resin adhesive was formed by a screen-printing process over the cathode layer. A flexible sealing layer provided with a barrier layer was bonded to the sealing layer. The flexible sealing layer provided with the barrier layer was formed by forming a 0.1 μm thick barrier layer 3 of SiON by a continuous evaporation system on a 100 μm thick flexible sealing layer of a poly(ether sulphone) resin formed by an extrusion process. Thus, an organic EL device 61 as shown in FIG. 6 was fabricated by a fabricating method including those wet processes.

As shown in FIG. 6, the organic EL device 61 was formed by bonding together an EL layer 5 becoming luminous in a sold color and a printed layer 1 provided with transparent patterns through which the EL layer 5 underlying the printed layer 1 can be seen.

The organic EL display devices 61 shown in FIG. 6 were used for the rotary display members shown in FIG. 1 and incorporated into the slot machine shown in FIG. 4. Light emitted from regions, corresponding to the transparent patterns of the printed layers 1, of the EL layers 5 displayed the patterns conspicuously. Thus, the application of the organic EL devices 61 to the slot machine enhanced the pleasure of playing with the machine and the amusement thereof.

As apparent from the foregoing description, according to the present invention, the self-luminescent organic EL device mounted on the outer surface of the rotary display member or the stationary display member is driven by a low voltage to emit bright light and is also capable of emitting light in multiple colors. Therefore, the problems in the conventional pattern display apparatus using light bulbs as light sources do not arise in the pattern display apparatus of the present invention. Thus, the pattern display apparatus of the present invention has an improved amusing effect and an improved soliciting effect, and is also advantageous in respect of maintenance and management.

What is claimed is:

1. A pattern display apparatus comprising:
a rotary or stationary display member; and
a flexible organic EL device provided on an outer surface of the rotary or stationary display member, the flexible organic EL device being capable of displaying a character, a figure, a mark and/or a pattern formed by combining some of a character, a figure and a mark.

2. A pattern display apparatus according to claim 1, wherein
the rotary display member rotates to display a variable patterning and stops to display a still patterning for a game machine.

3. A pattern display apparatus according to claim 1, wherein
the stationary display device is for POP advertisement.

4. A pattern display apparatus according to claim 1, wherein
the flexible organic EL device has a laminated structure formed by laminating at least a flexible base layer, a first electrode layer, an EL layer, a second electrode layer and a flexible sealing layer in that order.

5. A pattern display apparatus according to claim 4, wherein
an insulating layer of a predetermined pattern is provided for insulating the first electrode layer and the second electrode layer from each other in the laminated structure.
